(19) United States
(12) Patent Application Publication
(10) Pub. No.: US 2014/0016102 A1
(43) Pub. Date: Jan. 16, 2014

(54) DYNAMIC DIFFRACTIVE IMAGE PROJECTION DEVICE

(71) Applicant: FORWARD ELECTRONICS CO., LTD., Taipei (TW)

(72) Inventors: Yu-Wen CHEN, New Taipei City (TW); Hsien-Chih Chiu, New Taipei City (TW)

(73) Assignee: FORWARD ELECTRONICS CO., LTD., Taipei City (TW)

(21) Appl. No.: 13/659,096

(22) Filed: Oct. 24, 2012

(30) Foreign Application Priority Data
Jul. 10, 2012 (TW) 101213298

(51) Int. Cl. G03B 21/14

(52) U.S. Cl. CPC G03B 21/14
USPC 353/31

(57) ABSTRACT

A dynamic diffractive image projection device includes a first laser light source, a second laser light source, a third laser light source, a first dynamic diffractive optical element, a second dynamic diffractive optical element, a third dynamic diffractive optical element, a controller, and a combiner. The first, second, and third color beams provided by the first, second, and third laser light sources respectively pass through the first, second, third dynamic diffractive optical elements, which are controlled by the controller to perform real-time signal modulation for producing dynamic diffractive grating distributions, so as to produce a pixel corresponding to a specific position of an image frame. The combiner combines the color beams at the corresponding specific position. The controller performs a fast switching and playing on the first, second and third dynamic diffractive optical elements so as to project a two-dimensional full-color image frame by scanning.

### BACKGROUND OF THE INVENTION

1. Field of the Invention

The present invention relates to an image projection device and, more particularly, to a dynamic diffractive image projection device.

2. Description of Related Art

Laser has the advantages of high intensity, narrow band, and centralized light beam for providing high brightness, high color saturation, and high resolution in image projection. Therefore, laser is one of the best choices for light source of an image projection device. Accordingly, the image projection device using laser as a light source has become a tendency in display technology.

With reference to FIG. 1, there is shown a planar view of a prior laser micro projection device. In FIG. 1, the laser micro projection device includes three laser light sources 411, 412, 413; two beam splitters 421, 422, and one micro scanner 43. The three laser light sources provide a first color beam B411, a second color beam B412, and a third color beam B413, respectively. The first color beam B411 passes through the two beam splitters 421, 422. The second color beam B412 is reflected by the beam splitter 421 and then passes through the beam splitter 422. The third color beam B413 is reflected by the beam splitter 422. All these three color beams are combined into the micro scanner 43 so as to project a full-color image on the screen (not shown) by scanning of the micro scanner 43.

The key element, i.e. the micro scanner 43, of the prior laser micro projection device is a high-precision micro electromechanical system (MEMS), which is difficult in manufacture and thus is expensive, resulting in that the laser micro projection device is hard to be popular. Therefore, it is desirable to provide an improved image projection device to mitigate the aforementioned problems.

### SUMMARY OF THE INVENTION

The object of the present invention is to provide a dynamic diffractive image projection device so that the laser beam passing through a dynamic diffractive optical element directly produces a two-dimensional dynamic diffractive image

According to one aspect, the present invention provides a dynamic diffractive image projection device, which comprises a first laser light source for providing a first color beam having a first light intensity; a second laser light source for providing a second color beam having a second light intensity; a third laser light source for providing a third color beam having a third light intensity; a first dynamic diffractive optical element corresponding to the first laser light source for receiving the first color beam; a second dynamic diffractive optical element corresponding to the second laser light source for receiving the second color beam; a third dynamic diffractive optical element corresponding to the third laser light source for receiving the third color beam; a controller connected to the first, second and third laser light sources for dynamically adjusting the first, second and third light intensities, and also connected to the first, second and third dynamic diffractive optical elements for respectively controlling the first, second and third diffractive optical elements to perform real-time signal modulation for producing dynamic diffractive grating distributions, so that the first, second and third color beams pass through the first, second and third dynamic diffractive optical elements, respectively, for producing a pixel corresponding to a specific position of an image frame; and a combiner for allowing the first, second and third color beams to be combined at the corresponding specific position after passing through the first, second and third dynamic diffractive optical elements, respectively. Further, the controller performs a fast switching and playing on the first, second and third dynamic diffractive optical elements so as to project a two-dimensional full-color image frame by scanning.

According to another aspect, the present invention provides a dynamic diffractive image projection device, which comprises a first laser light source for providing a first color beam having a first light intensity; a second laser light source for providing a second color beam having a second light intensity; a third laser light source for providing a third color beam having a third light intensity; a combiner for receiving the first, second, and third color beams for combining the first, second and third color beams into a combined beam; a dynamic diffractive optical element for receiving the combined beam; and a controller connected to the first, second and third laser light sources for dynamically adjusting the first, second and third light intensities, and also connected to the dynamic diffractive optical element for controlling the dynamic diffractive optical element to perform real-time signal modulation for producing dynamic diffractive grating distributions, so that the combined beam passes through the dynamic diffractive optical element for producing a pixel corresponding to a specific position of an image frame. Further, the controller performs a fast switching and playing on the dynamic diffractive optical element so as to project a two-dimensional full-color image frame by scanning.

According to a further aspect, the present invention provides a dynamic diffractive image projection device, which comprises a light source module for providing a collimated beam; a hologram set including a plurality of holograms, each hologram having static diffractive grating distribution, so as to produce a static diffractive image when the collimated beam passes through each of the holograms; and a player for fast playing the plurality of holograms for allowing the static diffractive images produced from the plurality of holograms to be presented as a dynamic image.

Other objects, advantages, and novel features of the invention will become more apparent from the following detailed description when taken in conjunction with the accompanying drawings.

### BRIEF DESCRIPTION OF THE DRAWINGS

FIG. 1 is a planar view of a prior laser micro projection device;

FIG. 2(A) is a schematic diagram of the dynamic diffractive image projection device according to a preferred embodiment of the present invention;

FIG. 2(B) is a schematic diagram showing the image displayed on the screen according to the dynamic diffractive image projection device of the present invention;

FIG. 3 is a schematic diagram of the dynamic diffractive image projection device according to another preferred embodiment of the present invention; and

FIG. 4 is a schematic diagram of the dynamic diffractive image projection device according to a further preferred embodiment of the present invention.

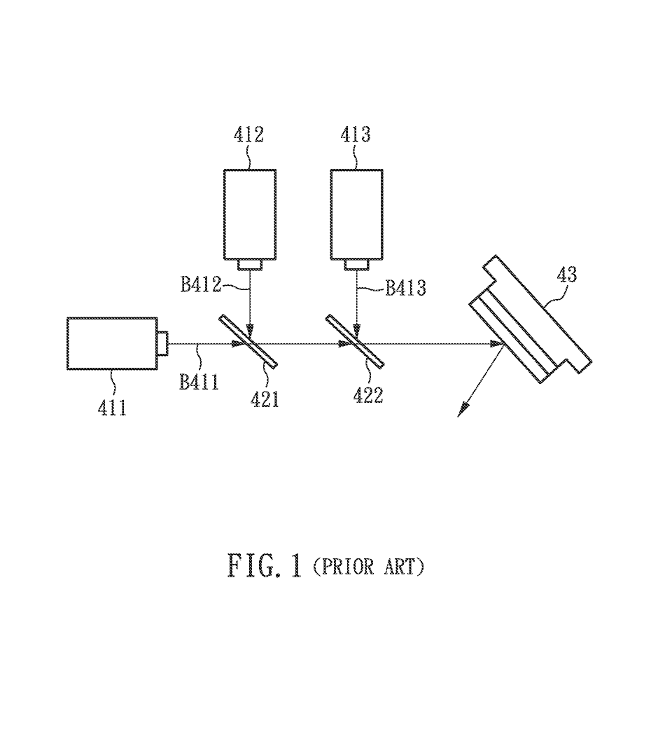

### DETAILED DESCRIPTION OF THE PREFERRED EMBODIMENT

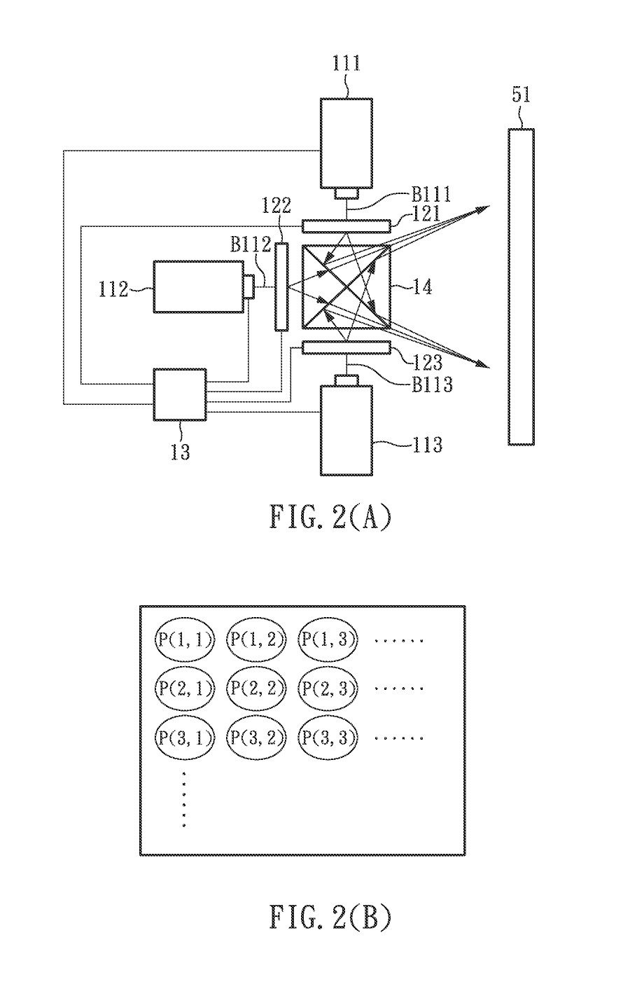

With reference to FIG. 2(A), there is shown the dynamic diffractive image projection device according to a preferred embodiment of the present invention. As shown in FIG. 2(A), the dynamic diffractive image projection device includes: a first laser light source 111, a second laser light source 112, a third laser light source 113, a first dynamic diffractive optical element 121, a second dynamic diffractive optical element 122, a third dynamic diffractive optical element 123, a controller 13, and a combiner 14.

The first laser light source 111, the second laser light source 112, and the third laser light source 113 are preferably disposed at locations so that the laser light source outputs thereof are perpendicular to each other. The first laser light source 111 provides a first color beam B111 having a first light intensity. The second laser light source 112 provides a second color beam B112 having a second light intensity. The third laser light source 113 provides a third color beam B113 having a third light intensity. In this embodiment, the first color beam B111 is preferably a red beam, the second color beam B112 is preferably a green beam, and the third color beam B113 is preferably a blue beam.

The first dynamic diffractive optical element 121 is disposed at a location to which the first laser light source lii outputs laser beam, for corresponding to the first laser light source 111 to receive the first color beam B111. The second dynamic diffractive optical element 122 is disposed at a location to which the second laser light source 112 outputs laser beam, for corresponding to the second laser light source 112 to receive the second color beam B112. The third dynamic diffractive optical element 123 is disposed at a location to which the third laser light source 113 outputs laser beam, for corresponding to the third laser light source 113 to receive the third color beam B113. In this embodiment, the first, second, and third dynamic diffractive optical elements 121, 122, 123 preferably are each a spatial light modulator or a dynamic grating.

The controller 13 is connected to the first, second and third laser light sources 111, 112, 113 for dynamically adjusting the first, second and third light intensities, and also connected to the first, second and third dynamic diffractive optical elements 121, 122, 123 for respectively controlling the first, second and third diffractive optical elements 121, 122, 123 to perform real-time signal modulation for producing dynamic diffractive grating distributions, so that the first, second and third color beams B111, B112, B113 pass through the first, second and third dynamic diffractive optical elements 121, 122, 123, respectively to produce pixels corresponding to a specific position of an image frame.

The combiner 14 is preferably disposed at a location surrounded by the first dynamic diffractive optical element 121, the second dynamic diffractive optical element 122 and the third dynamic diffractive optical element 123, so that the first, second and third color beams are combined at a corresponding specific position after passing through the first, second and third dynamic diffractive optical elements, respectively, so as to present a full-color image frame on the screen 51. In this embodiment, the combiner 14 is preferably an X-prism. The controller 13 performs a fast switching and playing on the first, second and third dynamic diffractive optical elements 121, 122, 123 so as to project a two-dimensional full-color image frame on the screen 51 by scanning. As shown in FIG. 2(B), there is a schematic diagram showing the image displayed on the screen 51 according to the dynamic diffractive image projection device of the present invention. At time t1, the controller 13 controls the first, second and third laser light sources 111, 112, 113, to emit the red, green, and blue beams B111, B112, B113 with the first, second and third light intensities, respectively, which pass through the first, second and third diffractive optical elements 121, 122, 123 and the combiner 14 to produce a pixel P(1,1) corresponding to a position (1, 1) of an image frame. At time t2, the controller 13 controls the red, green, and blue beams, which pass through the first, second and third diffractive optical elements 121, 122, 123 and the combiner 14 to produce a pixel P(1,2) corresponding to a position (1, 2) of an image frame. At time t3, the controller 13 controls the red, green, and blue beams, which pass through the first, second and third diffractive optical elements 121, 122, 123 and the combiner 14 to produce a pixel P(1,3) corresponding to a position (1, 3) of an image frame. Such a scanning process is repeated and, when the pixels of a line in the image frame have been produced, the pixels of the next line in the image frame are continuously produced in the same manner until all pixels of the image frame have been produced.

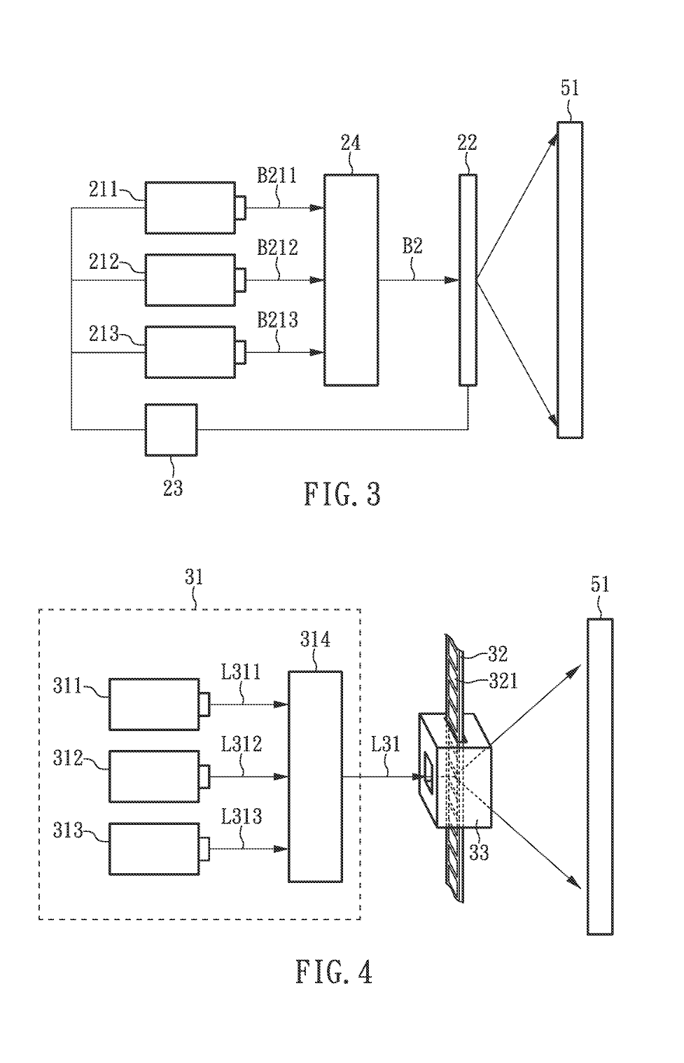

With reference to FIG. 3, there is shown a schematic diagram of another preferred embodiment of the present invention. As shown in FIG. 3, the dynamic diffractive image projection device includes a first laser light source 211, a second laser light source 212, a third laser light source 213, a combiner 24, a dynamic diffractive optical element 22, and a controller 23.

The first laser light source 211, the second laser light source 212, and the third laser light source 213 are preferably disposed at locations so that the laser light source outputs thereof are in parallel with each other. The first laser light source 211 provides a first color beam B211 with a first light intensity. The second laser light source 212 provides a second color beam B212 with a second light intensity. The third laser light source 213 provides a third color beam B213 with a third light intensity. In this embodiment, the first color beam B211 is preferably a red beam, the second color beam B212 is preferably a green beam, and the third color beam B213 is preferably a blue beam.

The combiner 24 is preferably disposed at a location to which the first laser light source 211, the second laser light source 212, and the third laser light source 213 output laser beams, so as to receive the first, second and third color beams B211, B212, B213 for combining the first, second and third color beams B211, B212, B213 into a combined beam B2. The combined beam B2 is then received by the dynamic diffractive optical element 22. In this embodiment, the dynamic diffractive optical element 22 is preferably a spatial light modulator or a dynamic grating. The controller 23 is connected to the first, second and third laser light sources 211, 212,for dynamically adjusting the first, second and third light intensities, and is also connected to the dynamic diffractive optical element 22 for controlling the dynamic diffractive optical element 22 to perform real-time signal modulation for producing dynamic diffractive grating distributions, so that the combined beam B2 passes through the dynamic diffractive optical element 22 to produce a pixel corresponding to a specific position of an image frame. The controller 23 performs a fast switching and playing on the dynamic diffractive optical element 22 so as to project a two-dimensional full-color image frame on the screen 51 by scanning. The image shown on the screen 51 by the dynamic diffractive image projection device of the present invention is the same as in FIG. 2(B). As shown, at time t1, the controller 23 controls the first, second and third laser light sources 211, 212, 213 to emit the red, green, and blue beams B211, B212, B213 with the first, second and third light intensities, respectively, which pass through the combiner 24 and the diffractive optical elements 22 to produce a pixel P(1,1) corresponding to a position (1, 1) of an image frame. At time t2, the controller 23 controls the red, green, and blue beams, which pass through the combiner 24 and the diffractive optical elements 22 to produce a pixel P(1,2) corresponding to a position (1, 2) of the image frame. At time t3, the controller 23 controls the red, green, and blue beams, which pass through the combiner 24 and the diffractive optical elements 22 to produce a pixel P(1,3) corresponding to a position (1, 3) of the image frame. Such a scanning process is repeated and, when the pixels of a line in the image frame have been produced, the pixels of the next line in the image frame are continuously produced in the same manner until all pixels of the image frame have been produced.

With reference to FIG. 4, there is shown a schematic diagram of a further preferred embodiment of the present invention. As shown in FIG. 4, the dynamic diffractive image projection device includes a light source 31 a hologram set 32, and a player 33.

The light source 31 provides a collimated beam L31. In this embodiment, the light source 31 further comprises: three laser light sources 311, 312, 313 for providing red, blue, and green beams, respectively; and a combiner 314 for combining the red, blue and green beams into the collimated beam L31.

The hologram set 32 includes a plurality of cascaded diffractive optical elements, such as a plurality of holograms 321 each hologram having static diffractive grating distribution, so as to produce a static diffractive image when the collimated beam L31 passes through each of the holograms 321.

The player 33 is provided for fast playing the hologram set 32 so as to allow the static diffractive images produced from the plurality of holograms 321 to be presented as a dynamic image.

In view of the foregoing, it is known that the present invention makes use of dynamic diffractive optical elements to replace the prior micro scanner for designing the dynamic diffractive image projection device, which has the advantages of easy manufacture and low cost and which is able to produce the two-dimensional dynamic image.

Although the present invention has been explained in relation to its preferred embodiment, it is to be understood that many other possible modifications and variations can be made without departing from the spirit and scope of the invention as hereinafter claimed.

What is claimed is:

1. A dynamic diffractive image projection device, comprising:
a first laser light source for providing a first color beam having a first light intensity;
a second laser light source for providing a second color beam having a second light intensity;
a third laser light source for providing a third color beam having a third light intensity;
a first dynamic diffractive optical element corresponding to the first laser light source for receiving the first color beam;
a second dynamic diffractive optical element corresponding to the second laser light source for receiving the second color beam;
a third dynamic diffractive optical element corresponding to the third laser light source for receiving the third color beam;
a controller connected to the first, second and third laser light sources for dynamically adjusting the first, second and third light intensities, and also connected to the first, second and third dynamic diffractive optical elements for respectively controlling the first, second and third diffractive optical elements to perform real-time signal modulation for producing dynamic diffractive grating distributions, so that the first, second and third color beams pass through the first, second and third dynamic diffractive optical elements, respectively, for producing a pixel corresponding to a specific position of an image frame; and
a combiner for allowing the first, second and third color beams to be combined at the corresponding specific position after passing through the first, second and third dynamic diffractive optical elements, respectively;
wherein the controller performs a fast switching and playing on the first, second and third dynamic diffractive optical elements so as to project a two-dimensional full-color image frame by scanning.

2. The dynamic diffractive image projection device of claim 1, wherein the first color beam is a red beam, the second color beam is a green beam, and the third color beam is a blue beam.

3. The dynamic diffractive image projection device of claim 1, wherein each of the first, second and third dynamic diffractive elements is a spatial light modulator.

4. The dynamic diffractive image projection device of claim 1, wherein each of the first, second and third dynamic diffractive elements is a dynamic grating.

5. The dynamic diffractive image projection device of claim 1, wherein the combiner is an X-prism.

6. A dynamic diffractive image projection device comprising:
a first laser light source for providing a first color beam having a first light intensity;
a second laser light source for providing a second color beam having a second light intensity;
a third laser light source for providing a third color beam having a third light intensity;
a combiner for receiving the first, second, and third color beams and combining the first, second and third color beams into a combined beam;
a dynamic diffractive optical element for receiving the combined beam; and
a controller connected to the first, second and third laser light sources for dynamically adjusting the first, second and third light intensities, and also connected to the dynamic diffractive optical element for controlling the dynamic diffractive optical element to perform real-time signal modulation for producing dynamic diffractive grating distributions, so that the combined beam passes through the dynamic diffractive optical element for producing a pixel corresponding to a specific position of an image frame, wherein the controller performs a fast switching and playing on the dynamic diffractive optical element so as to project a two-dimensional full-color image frame by scanning.

7. The dynamic diffractive image projection device of claim 6, wherein the first color beam is a red beam, the second color beam is a green beam, and the third color beam is a blue beam.

8. The dynamic diffractive image projection device of claim 6, wherein the dynamic diffractive optical element is a spatial light modulator.

9. The dynamic diffractive image projection device of claim 1, wherein the dynamic diffractive optical element is a dynamic grating.

10. The dynamic diffractive image projection device of claim 1, wherein the combiner is an X-prism.

11. A dynamic diffractive image projection device, comprising:
a light source module for providing a collimated beam;
a hologram set including a plurality of holograms, each hologram having static diffractive grating distribution, so as to produce a static diffractive image when the collimated beam passes through each of the holograms; and
a player for fast playing the plurality of holograms for allowing the static diffractive images produced from the plurality of holograms to be presented as a dynamic image.

12. The dynamic diffractive image projection device of claim 11, wherein the light source module comprising:
three laser light sources for providing a red beam, a blue beam, and a green beam, respectively; and
a combiner for combining the red, blue and green beams into the collimated beam.
